(19) United States
(12) Patent Application Publication
(10) Pub. No.: US 2006/0084317 A1
(43) Pub. Date: Apr. 20, 2006

(54) Play/athletic training appliance

(76) Inventors: Sven-Ake Sjostam, Aneby (SE); John Granstrom, Aneby (SE)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/230,899

(22) Filed: Sep. 20, 2005

Related U.S. Application Data
(60) Provisional application No. 60/611,340, filed on Sep. 20, 2004.

(51) Int. Cl. H01R 13/60

(52) U.S. Cl. 439/527

(57) ABSTRACT

The present invention relates to a play/athletic training appliance, which is characterized in that it comprises at least one open spiral or the like, in a plane with two separate parallel, ends and an intermediate gripping part. The parallel ends are turnably fastened to a fixed base.

### CROSS-REFERENCE TO RELATED APPLICATIONS

This application is related to U.S. Provisional Patent Application No. 60/611,340 filed Sep. 20, 2004 from which priority is claimed, and is hereby incorporated by reference.

### STATEMENT REGARDING FEDERALLY SPONSORED RESEARCH

Not Applicable.

### BACKGROUND OF THE INVENTION

The present invention relates a play/athletic training appliance. The appliance is in the first place intended for use in playgrounds or similar environments, but can also advantageously be used as a training appliance.

### SUMMARY OF THE INVENTION

The appliance according to the present invention relates to a new shape of acrobatic rings. A ring according to the invention has the form of an open spiral with parallel ends that are fastened in a manner that provides an interesting pivoting and resilient motion when a user hangs from the ring or sits in it. The main function of the invention is that the user should hang by the knees or sit in the ring, or hold the ring with his hands and swing to and fro.

The play/athletic training appliance provides a different and new approach, which makes a new and exciting form of acrobatics possible.

The play/athletic training appliance comprises at least one open spiral or the like, in a plane with two separate parallel ends and an intermediate gripping part. The ends are turnably fastened to a fixed base.

The foregoing and other features, and advantages of the invention as well as embodiments thereof will become more apparent from the reading of the following description in connection with the accompanying drawings.

### DESCRIPTION OF THE DRAWINGS

In the accompanying drawings which form part of the specification:

FIG. 1a illustrates the appliance according to the invention in a first embodiment where the appliance is essentially circular,

FIG. 1b shows the appliance according to the invention in a second embodiment where the appliance is non-circular,

FIG. 2 shows fastening of the appliance according to FIGS. 1a and 1b,

FIG. 3 shows the appliance according to the invention arranged according to a second embodiment,

FIG. 4 is a cross-section of the fastening in FIG. 2, and

FIG. 5 shows two appliances according to the invention mounted on a stand.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

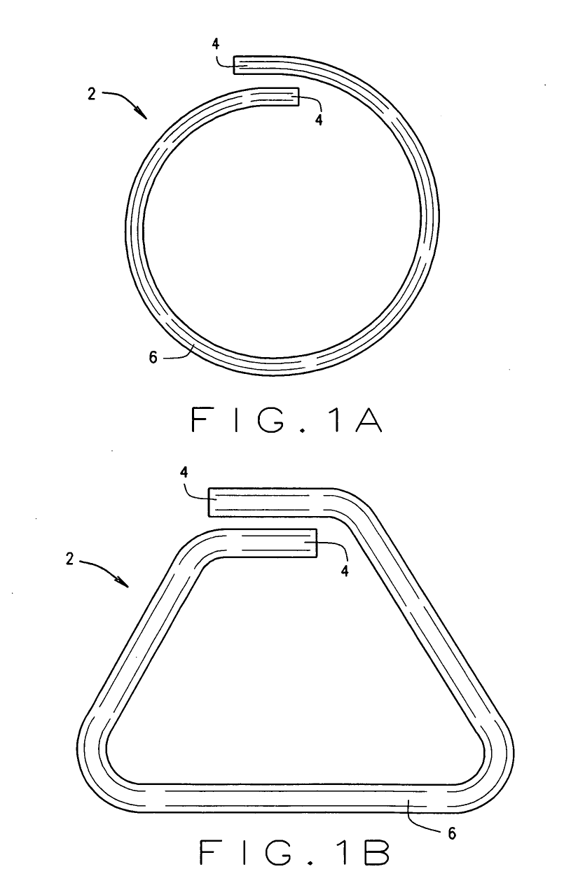

The play/athletic training appliance according to the invention comprises at least one open spiral which is designated 2 in the drawings. According to the invention, the term “spiral” relates to a device of a shape which may be described as an open loop which has two independent ends that are not intended to meet, see FIGS. 1a and 1b. The spiral 2 is arranged in a plane with two separate parallel ends 4 and an intermediate gripping part 6. The spiral 2 according to the invention is intended for a user to hang from, either with his hands grasping the spiral or by the knees, or by sitting in the spiral.

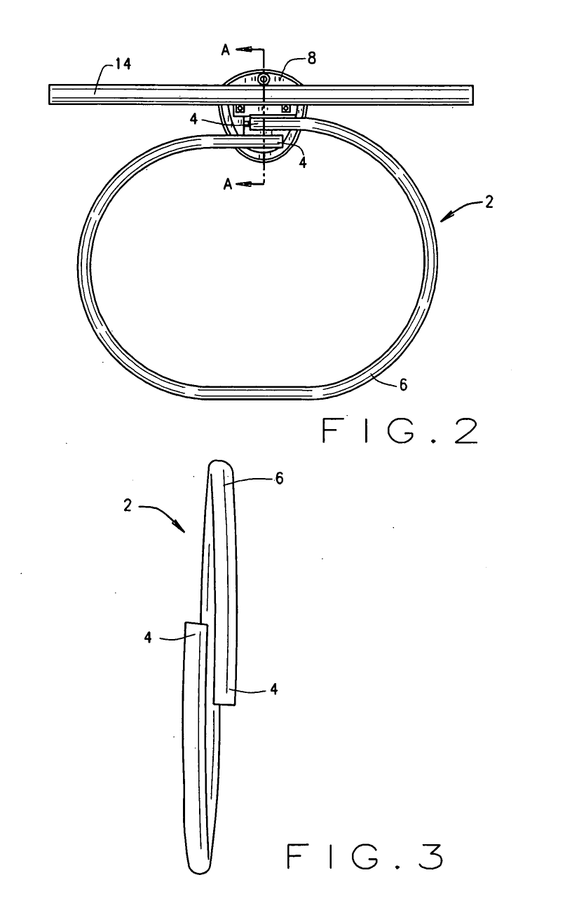

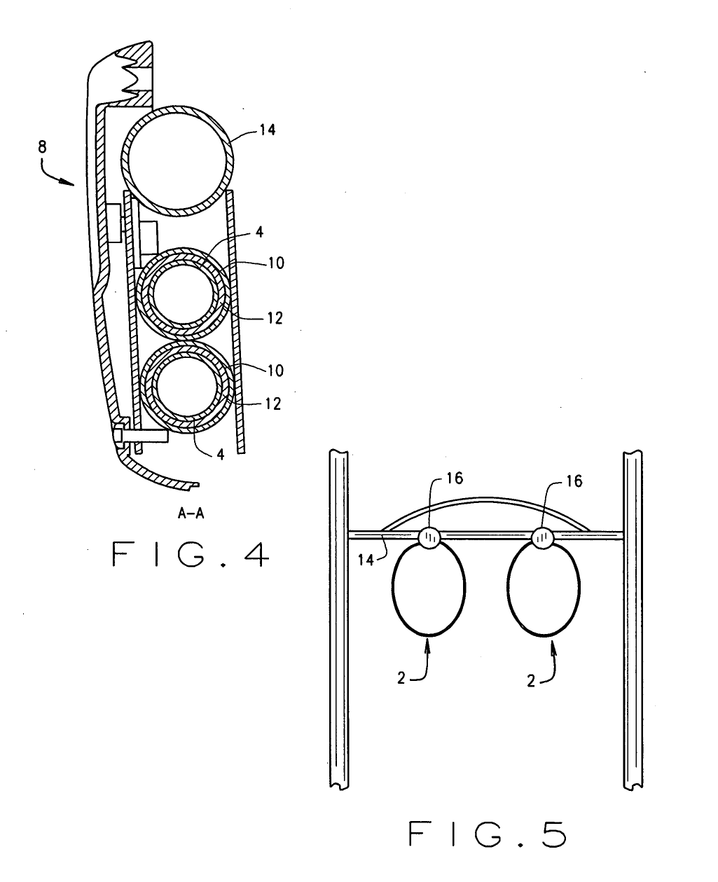

The center of the spiral 2 is offset by the ends 4 of the spiral 2 being offset in the plane of the spiral 2 separate from each other or overlapping each other. In another embodiment, the ends 4 of the spiral 2 are offset perpendicular to the plane of the spiral 2, see FIG. 3, either separate from each other or overlapping each other.

The spiral is made of a resilient material and advantageously comprises a steel tube, but it can also be made of a solid rod, carbon fibre reinforced plastic, some other type of plastic material or the like. In a first embodiment, the spiral 2 is essentially circular, see FIG. 1a, and is formed so that the longitudinal axes of the ends 4 are parallel. The essentially circular spiral 2 has a size of about 500-1000 mm, preferably about 700 mm, but may of course be made larger and smaller and with a different geometrical, symmetrical or unsymmetrical shape according to wishes and needs. FIG. 1b shows an example of a non-circular spiral 2.

The parallel ends 4 of the spiral 2 are arranged movably in a common holder 8. Fastening devices 10 are arranged in the holder 8 in the form of bearing sleeves which are essentially fixedly arranged. The fastening devices 10 can also comprise other types of elements. The bearing sleeves are provided with bearings 12. The fastening devices 10 in the form of bearing sleeves are used for fastening to the fixed base which comprises the holder 8. The ends 4 of the spiral 2 are inserted into the fastening devices 10. The bearings 12 can be, for example, slide bearings, roller bearings, ball bearings or rubber bearings. The ends 4 are turnably fastened to the fastening devices 10.

A fastening entirely of rubber where the fastening device 10 and the bearings 12 are made of rubber can be used in the present invention, but such fastening manages swinging of a device according to the invention by ±30° maximum and will after that break. It is therefore advantageous to use fastening devices 10 in the form of bearing sleeves of steel with bearings 12 inside, such as slide bearings, roller bearings or ball bearings.

The fastening in the holder 8 is completely rigid in such a manner that the sleeves have a fixed position, which forces the material of the spiral 2 to twist in the fastening devices 10. Thus, it is the actual dead weight of the material of which the spiral is made that causes the swinging. The ends 4 of the spiral 2 are arranged to be fastened to the holder 8, in which holder 8 also a transverse bar 14 is fixedly arranged and which is fastened to some kind of stand or the like according to prior art technique and standards, see FIG. 5. The holder 8 is enclosed by a casing 16 to prevent dirt and the like from entering and affecting the fastening of the spiral 2, and also for aesthetic reasons.

The construction of the spiral 2 improves the function by the two ends 4 of the spiral 2 meeting each other at a parallel distance. Both ends are inserted into the fastening devices which are provided with bearings 12 so that the spiral 2 can swing to and fro. In the actual swinging motion, tension arises in the spiral 2 and gives it the same properties as if it were spring tensioned. Owing to the fastening of the construction, the swinging resistance will be greater the greater the swinging at an angle to which the spiral 2 is subjected. Of course, this phenomenon continues until the change in angle passes about ±90°.

The resilience of the spiral 2 obtains a minimum tension in the position of rest, the vertical position, and return tension when swinging perpendicular to the plane of the spiral 2. Forces due to tension that arise in the deviation of the spiral 2 from the vertical position strive to return the spiral 2 to the vertical position.

The present invention has now been described by means of a number of embodiments, and it should be understood that various modifications and supplements can be made within the scope of the invention as defined in the appended claims.

REFERENCE NUMERALS

| | |
|---|---|
| Spiral | 2 |
| End | |
| Gripping part | |
| Holder | |
| Fastening device | 10 |
| Bearing | 12 |
| Transverse rod | 14 |
| Casing | 16 |

What is claimed is:

1. A playground swinging appliance comprising:
at least one open spiral in a plane with two separate parallel ends and an intermediate gripping part,
the ends being turnably fastened to a fixed base.

2. The playground swinging appliance of claim 1, further comprising:
fastening devices provided with bearings, the fastening device being used for fastening to the fixed base.

3. The playground swinging appliance of claim 1, wherein the resilience of the spiral obtains a minimum tension in the position of rest, and returns tension when swinging perpendicular to the plane of the spiral.

4. The playground swinging appliance of claim 1, wherein the ends of the spiral are offset in the plane of the spiral.

5. The playground swinging appliance of claim 1, wherein the ends of the spiral are offset perpendicular to the plane of the spiral.

6. The playground swinging appliance of claim 2, wherein the ends of the spiral are offset perpendicular to the plane of the spiral.

7. The playground swinging appliance of claim 3, wherein the ends of the spiral are offset perpendicular to the plane of the spiral.

8. The playground swinging appliance of claim 1, wherein forces due to tension that arise in the deviation of the spiral from the vertical position strive to return the spiral to the vertical position.
